(19) United States
(12) Patent Application Publication
(10) Pub. No.: US 2003/0135391 A1
(43) Pub. Date: Jul. 17, 2003

(54) Method and system for analyzing health information

(76) Inventors: Catherine M. Edmundson, Dunlap, IL (US); Richard C. Luetkemeyer, Peoria, IL (US); Beverlee L. Gilmore, Peoria, IL (US); Donald J. Crane, Brimfield, IL (US)

Correspondence Address: CATERPILLAR INC., 100 N.E. ADAMS STREET, PATENT DEPT., PEORIA, IL, 616296490

(21) Appl. No.: 10/285,656

(22) Filed: Oct. 31, 2002

Related U.S. Application Data
(60) Provisional application No. 60/334,982, filed on Oct. 31, 2001.

(51) Int. Cl. G06F 17/60; H04N 5/91; H04N 7/04; H04N 7/08; G06F 7/00; G06F 17/00

(52) U.S. Cl. 705/2; 705/14; 386/96; 707/104.1

(57) ABSTRACT

The present invention includes a method and system configured to establish a repository of health related information. The health related information may be used to manage a health care program. The method includes the steps of establishing a population, the population having a plurality of members, and establishing said repository of health related information associated with at least one of said members, the health related information including a health characteristic, a family health characteristic, and a lifestyle characteristic associated with the member.

This application claims the benefit of prior provisional patent application Serial No. 60/334,982, Filed Oct. 31, 2001.

### TECHNICAL FIELD

This invention relates generally to a method and system of analyzing health related information, and more particularly, to a method and system configured to establish a repository of health related information.

### BACKGROUND

Effective management of health care programs is difficult. Health care costs continue to increase, and the causes of health problems, continue to evolve. Therefore, understanding what actions to take to provide cost effective health care is difficult. Some systems exists today that attempt to analyze some health information about people. However these systems do not collect and/or analyze the relevant information to obtain accurate results. In addition, the limited analysis performed by these systems does not include establishing and using data to make cost effective solutions to improving health care of a population while reducing health cost.

The present invention is directed to overcoming one or more of the problems set forth above.

### SUMMARY OF THE INVENTION

In one aspect of the present invention, a method of establishing a repository of health related information is disclosed. The method includes the steps of establishing a population, the population having a plurality of members, and establishing the repository of health related information associated with at least one of said members, the health related information including a health characteristic associated with the member, and a family health characteristic associated with said member.

### BRIEF DESCRIPTION OF THE DRAWINGS

FIG. 1 is an illustration of one embodiment of a method of establishing a repository of health related information;

FIG. 2 is an illustration of one embodiment of a method of managing a health care program; and

FIG. 3 is an illustration of one embodiment of a system configured to establish a repository of health related information.

### DETAILED DESCRIPTION

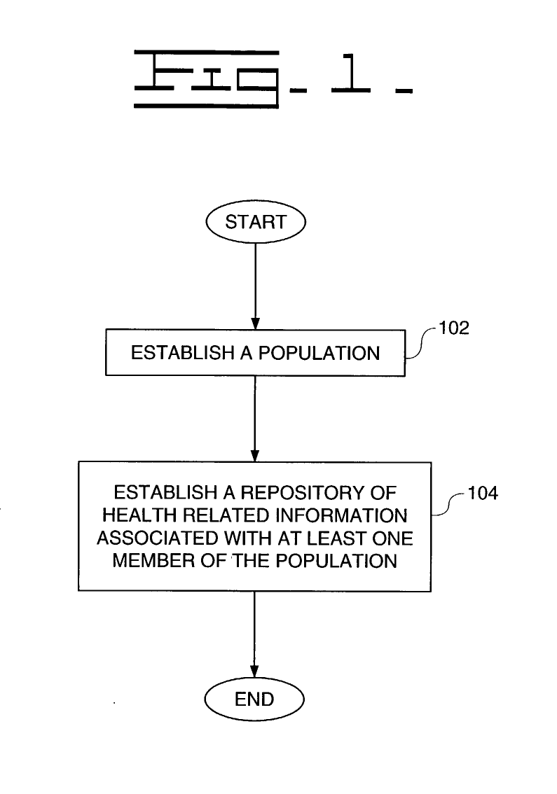

The present invention includes a system and method of establishing a repository of health related information. The established repository may then be analyzed to establish characteristics associated with the health-related information and/or the associated population. In one embodiment, the established repository may be used to manage a health care program. As illustrated in FIG. 1, the method includes the steps of establishing a population, and establishing the repository of health related information associated with at least one of the members of the population. In a first control block 102, a population associated with the repository is established. The population includes a plurality of members. In one embodiment, the population associated with the repository may be established by establishing the environment in which the repository is to be used. For example, the repository may be used to enable the management of a health care program within a corporation.

A population criteria may be used to establish the population associated with the repository. In one embodiment, a corporation (for example) may establish the criteria such that all employees, spouses and dependents are included in the health care program. In this environment, the repository population is all employees, spouses and dependents. In another embodiment, the corporation may want to create a repository for each facility, or for employees only. Alternatively the corporation may want to create multiple repositories associated with different job classifications within the corporation. Therefore, criteria (or characteristics) such as facility identification, location, job classification, employment status (e.g., retired or active), full-time or part-time, spouses, and dependents, associated with a corporations employees may be used to establish the population that will be associated (based on the criteria) with the repository, or database, of health related information. In one embodiment, the repository population will include all the corporations employees and retirees, and associated spouses and dependents. In one embodiment, the population may be expanded to include associates of the corporation, e.g., contractors, suppliers, dealers, etc. In addition, in one embodiment the population may be specifically identified by searching a database of corporate employee records, using the established criteria, and adding any matches of the criteria with the population characteristics into the repository. Alternatively the employee database may simply be used as the population associated with the repository.

In an alternative embodiment, the population may not be associated with a specific corporation, but may be associated with members of the public. For example, a private health care provider may establish the repository using the population criteria of anyone who applies (or is accepted) into the program. For example if a person is accepted into the program, their names are included in the population. In addition, the names of their spouses and dependents may also be included in the repository. Alternatively, the repository may include a population made up of one or more specific corporations, and members of the general public. For example, a private health care provider may manage the health care programs for multiple corporations. In this embodiment, the established eligible employees and their associated spouses and dependents may be included in the population. In one embodiment, private-paying members, of the public may also be included to form the repository.

Once the population associated with the repository is established, the repository of health related information associated with the population may be established, as illustrated in control block 104. The health related information collected is associated with at least a portion of the population. In one embodiment, the health related information collected is associated with the whole population. However, the amount and type of information collected associated with the population may vary based upon the participation of the population, and the relevance of the information to the different members of the population. Therefore the information established may only be associated with a subset, or portion, of the established population. In one embodiment, the health related information includes a health characteristic, a family health characteristic, and a lifestyle characteristic associated with a member of the population. Member health characteristics may include characteristics indicative of a specific member's health. For example, a member health characteristic may include medical claim characteristics, drug claim characteristics, a death characteristic (e.g., information associated with a death certificate), an absenteeism characteristic, the number of days the member has spent in a medical facility (e.g., a hospital), and the number of visits the person has made to a doctor. At least one of the member health characteristics may be obtained from an independent source. For example, information from a doctor, hospital, pharmacist etc., may be used to establish the member health characteristic. The information may be obtained manually be contacting the independent source (e.g., doctor, hospital, pharmacist etc.), and obtaining the information. Alternatively, or in addition, a computing system associated with the independent source may automatically notify one or more authorized computing systems or repositories, upon the update of a member health characteristic, such as medical claim and drug claim data. In another embodiment, a computing system associated with the repository may access other identified computing systems to request updates to member records, such as medical claim and drug claim data. A self-assessment, as will be described below, may be used to obtain information associated with at least one health characteristic, a family health characteristic, and/or a lifestyle characteristic of the member. For example a self-assessment characteristic may include a self-reported health characteristic and/or a self-efficacy characteristic. A self-efficacy characteristic, as will be discussed, includes an indication of a member's willingness to change a lifestyle characteristic, which will lead to improved health. Self-assessments may be obtained, in one embodiment, through the use of one or more health-related questionnaires submitted to the member. The responses to the questionnaires may include a member's self assessed health characteristics. Alternative techniques may be used to gather self assessed information, such as phone interviews, in person interviews, member interaction with a web-site, etc.

In one embodiment, a family health characteristic associated with the member may include information associated with the family medical history of a specific member. For example, is there a history of a particular health risk within the family, e.g., heart failure, cancer, high blood pressure, stress etc. Family medical history may be established through self-reported information from the member. Alternatively, the information may be obtained from an independent source. The independent source may include a member's medical or drug claim records (e.g., via a hospital, doctor, pharmacist, or associated records etc.), or by identifying the member's relevant family members and directly acquiring the desired information from the identified family members medical records. For example, a computing function may establish a member within the population to gather more information on. The computing function may then determine the names of the member's family from the repository. Alternatively the computing function may automatically search (or request another computing function to search) a second database which may be either internal to the system or external, for the family member names. Once the family member names are obtained, the computing function may request associated medical and drug records of the family members. In one embodiment, prior authorization from the member and family members would be acquired to enable access to this information. Then, the computing function may automatically access a computing system associated with an identified medical and/or drug records database of a hospital or some other medical organization to access the information.

In addition, the health related information includes information associated with a lifestyle characteristic associated with a member. A lifestyle characteristic includes a specific member's behavior characteristic(s), of which some or all may be modifiable lifestyle characteristics. A modifiable lifestyle characteristic is a lifestyle characteristic of a specific member that provides an indication of the member's current or future health, and which may be modifiable. For example, modifiable lifestyle characteristics may include an exercise characteristic (e.g., does the member exercise, how often, what is the exercise etc.) and/or a nutrition characteristic (e.g., what types of food does the member eat, and how often). Nutrition characteristics may also include the amount of salt consumed during a designated period (e.g., a day), and the amount of fat and/or saturated fat consumed during a designated period. In addition, the modifiable lifestyle characteristics may include whether the member drinks alcohol (and if so how much), a drug intake characteristic, (i.e., does the member take drugs, and if so how often, what kind, and how much), a weight characteristic (e.g., what does the member weigh, what is the member's desired weight, is the member on a diet, what is the member's weight indicator e.g., obese, slightly overweight, anorexic, normal etc.), a smoking characteristic (does the member smoke and if so how much), a safety characteristic (what are the member's driving characteristics e.g., does the member where seat belts, have one or more infractions associated with driving under the influence (of alcohol etc.), or speeding tickets, or drive excessively fast etc.). In addition, the modifiable lifestyle characteristic may include a hypertension characteristic, a stress characteristic, a self-care characteristic, a self-efficacy characteristic, and a prophylactic aspirin therapy characteristic. In one embodiment, the health related information may also include one or more of the following: the location or geography, age, gender, employment status, and employment type of the member. The lifestyle characteristic may be established through a self-assessment or an independent source.

In addition, the repository may also include a list or table of health risk, and associated measurement of the health risk. The health risk measurement may be an incidence of disease associated with a particular health risk, or a ranking of a particular health risk with respect to frequency or significance, or a weighting associated with a particular health risk, associated with frequency or significance of the health risk. The list of health risk may be associated with the population. In one embodiment, the measurement of health risk associated with the population may be available when the repository is initially created. That is, what health risks currently exist in the population, or are known to exist. Alternatively, the measurement of a health risk associated with the population is created in response to analysis of the health-related information, and is updated as deemed appropriate. In addition, the repository may include a list of health risk associated with a second population. The second population may be a national measurement (e.g., incidence etc.) of the health risk, or the incidence of the health risk in analogous parts of the country, or analogous working environments of the population members. The health risk may be a known disease, heart attack, or other form of health risk. The health risk measurement may be further categorized based on age, gender, type of work, location (e.g., area of the world/country/state etc.).

In one embodiment, the repository may also include health care costs associated with the established health risks. Health care costs may be based on the health care cost associated with the population, or a second population. For example, the health care cost may be a national average health care cost. The health care cost may be associated with a particular health risk. In addition, the health care cost associated with the population will be monitored and updated accordingly. For example, as will be discussed below, information associated with health characteristics, e.g., the medical claims, drug claims, absenteeism, number of days in a medical facility or visits to a doctors office may be correlated to a health risk of a member and used to update the health care cost of the population associated with that health risks in particular, and/or health care cost of the population as a whole.

In one embodiment, the establishment of the repository may include establishing one or more lifestyle change initiatives, also referred to as techniques or intervention methods. For example, one or more change inducing technique associated with a modifiable lifestyle characteristic may be identified. As will be discussed below, the lifestyle change inducing technique may be an intervention method targeted to influence a member of the population to alter their modifiable lifestyle characteristic, e.g., reduce the number of cigarettes they smoke, or alcoholic beverages they drink etc. In addition, a success characteristic may be associated with the lifestyle change inducing technique (or intervention method). For example, providing educational literature to smokers in an attempt to get them to reduce or quit smoking may be found to be 30% effective in achieving the desired smoking reduction. Therefore in one embodiment, the success characteristic may be established to be 30%. In one embodiment, the success characteristic may be established in response to the success of the lifestyle change inducing technique when applied to a second population. That is, the success characteristic may be a national average for example. However, as will be discussed, a success characteristic of the lifestyle change inducing technique may be established based on applying the change inducing technique to the established population, or a portion thereof, and monitoring and recording the results. Therefore the success characteristic may be specific to the population, and may even be specific to a member of the population.

Therefore, in one embodiment, the repository may include the measurement of a health risk associated with the population (or applied to the population based upon analysis of a second population), lifestyle characteristics that may effect the health risk, the health care cost associated with the health risk, and the effectiveness (or success) and/or associated cost of change inducing techniques (or intervention methods) when applied to members exhibiting the lifestyle characteristics associated with the health risk. This information, along with the other information in the repository, may be used to manage a health care program associated with the population. For example, the information may be used to understand which health risk have the most cost effective chance of being avoided, what lifestyle characteristics contribute to the health risk, which members exhibit these lifestyle characteristics, and how best to influence the member to change the contributing lifestyle characteristics, thereby avoiding the health risk, thereby increasing the health of the member of the overall health of the population, while reducing the overall cost associated with health care. In addition, the information may be used to further develop the correlation between lifestyle characteristics and modifiable health risks. Modifiable health risks are health risk that may be modified by a change, e.g., a change in lifestyle characteristics. For example, information associated with members with health risks may be analyzed to determine what lifestyle characteristics (known or identified through this evaluation) the member exhibits which may have contributed to the health risk. For example, trending and correlation analysis over several years of data collection may indicate new or revised correlations of lifestyle characteristics to health risk. In addition, new or revised lifestyle changing initiatives may be used to determine their impact on changing a member's lifestyle. The success of these new or revised initiatives may be documented for further use. In addition, the analysis may be documented for the population in general, or a specific member of the population.

The above health related information may be established using one or more techniques. These techniques may include manual data entry, electronic integration with existing databases, web-enabled data entry, voice communications, personal interviews, and/or feedback from questionnaires. In one embodiment, electronic integration with existing databases may be used to establish the information. For example, a hospital may have a database of medical information associated with a specific member, e.g., medical claims, medical analysis, etc. The repository being established may be able to access identified hospital databases to acquire information associated with a specific member. Alternatively, during or after a medical analysis is performed, or medical claim issued, the medical information may be electronically communicated to the repository, or a manager of a repository. For example, an email from a hospital may be delivered to a manager of a repository, who may then manually or in an automated manner, enter the information into the database. Alternatively, the hospital database may have the ability to automatically communicate with the repository and send the desired health related information to the repository. For example, whenever the hospital records are updated for a particular member, the hospital computing system may automatically send an electronic communication to the repository to update the repository appropriately. In one embodiment, drug claims from either a hospital or drug provider may be electronically communicated to the repository, or manager of the repository, as described above. In one embodiment, a web site may be established such that a specific member may be able to electronically communicate health-related information to the repository. For example, a member may access a web site, and manually enter health-related information. Alternatively, the member may send an e-mail containing health related information to the repository or a manager of the repository. In addition, some information may be manually entered into the repository. For example, if paper copies of medical and drug claims are received, then a person may manually enter the health related information specific to the identified member, into the repository. In addition, electronic searches may be done to determine the member's relevant family members with respect to establishing a family history. The medical records of the relevant family members may be requested from the member, or associated medical facility, or automatically acquired through electronic communication with a second database containing the desired information. For example, upon receiving consent from the member, a computer system may automatically connect to a second repository, e.g., medical facility, and access the repository to acquire the relevant information regarding the members family history.

In addition, information may be solicited and received from the member. For example, specific health information may be received by making telephone calls to specific members, asking specific health related questions, and then entering the received information into the repository. In addition, questionnaires may be established, and then sent to specific members. The members may then respond with feedback which is then manually entered into the repository. In one embodiment, additional questionnaires (targeted questionnaires) may be sent to specific members in response to the answers provided on one or more prior questionnaires. The feedback from these targeted questionnaires may then be manually entered into the repository.

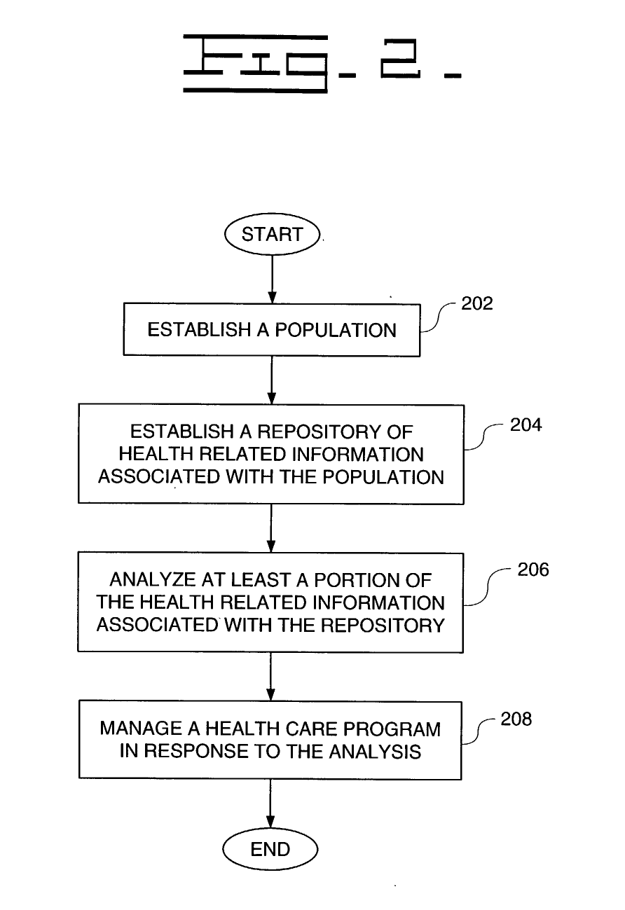

In one embodiment, the repository of health related information may be used to manage a health care program. The health care program may be managed by a corporation, for the employees of the corporation. Alternatively, the health care program may be managed by a health care organization, for the employees of one or more corporations unrelated to the health care organization. Alternatively, or in addition to, the health care program may be for participants of the general public, e.g., people who pay to be part of the health care program. FIG. 2 illustrates one embodiment of a method managing a health care program. The method includes the steps of establishing a population to be managed, developing a repository of health related information associated with the population, analyzing the health related information, and managing the health care program in response to the analysis. In one embodiment, the management of the health care program may include one or more of the steps of performing an action in response to the analysis, recording the results of the action relative to the health characteristics of the population, analyzing the results, and if appropriate, performing a second action in response to the analyzed results of the first action.

In a first control block 202, the population to be managed may be established. The population includes a plurality of members. The population may be established as described above with respect to FIG. 1.

In a second control block 204, a repository of health related information associated with the population is established. In one embodiment, the health related information includes a health characteristic, a family characteristic, and a lifestyle characteristic associated with a member of the population. The repository may be established as described above with respect to FIG. 1.

In a third control block 206, the repository may be analyzed with respect to the health-related information. In one embodiment, the health care program may be managed by establishing cause and effect relationships between lifestyle characteristics and a health risk. In one embodiment, the health risk includes modifiable health risk, and the lifestyle characteristics are associated with the modifiable health risk. In one embodiment, the modifiable health risk may be established by a process separate from this invention, e.g., independent medical research etc., and the results of the research may be incorporated into the repository of health related information. For example, the independent medical research may indicate which health risks are modifiable, and what lifestyle characteristics contribute to the health risk, and in what manner the characteristics contribute. For example, the study may indicate that lung cancer is a modifiable health risk. In addition, the study may indicate that smoking contributes to lung cancer, e.g., a member smoking has a 60% chance of contracting lung cancer. In one embodiment, the modifiable health risks may be determined (or modified) through analysis of the health information of the repository. Other lifestyle characteristics may be included in the analysis, such as age, gender, country, employment type etc. In addition, there may be several lifestyle characteristics that contribute to the modifiable health risk, and the combination of some lifestyle characteristics may have an impact on the modifiable health risk in a manner different from simply the additive effect of the individual lifestyle characteristics. In this environment, i.e. when the results of a correlation between lifestyle characteristics (e.g., modifiable lifestyle characteristics) and modifiable health risks are developed by an external source, the results may be stored in the repository. As will be discussed, the correlation of lifestyle characteristics and modifiable health risk may be performed as a result of the analysis of the health related information of the repository. The correlation between lifestyle characteristics and modifiable health risk may be used to perform analysis of the established population, or a portion thereof. In addition, once correlation results are established, they may be modified in light of the analysis of the population, or portion thereof. For example, a national survey may indicate a person who smokes has a 60% chance of contracting lung disease. However, as time goes on, analysis of the established population may be used to modify the stored correlation to customize the correlation to the population at hand. For example, the population, or a portion thereof, associated with the repository may only exhibit a 50% chance of contracting lung disease. Alternatively, the repository of health related information may be used to establish the relationship between a lifestyle characteristic and a health risk. For example, in one embodiment, the health characteristics of a member may be analyzed to determine what health risks the members of the population, or a portion thereof, exhibit. Then the lifestyle characteristics of the members may be correlated with the health risk to establish baseline correlations of health risk and lifestyles. The result of the baseline correlations may indicate 60% of the population that has lung cancer actually smokes, as compared to a national metric indicating that 70% of the population that has lung cancer actually smokes. This type of information may be further analyzed to indicate what the chances are that if a member smokes, they will contract lung cancer. In addition to this, these baseline correlations may be further refined as additional information and analysis of the population is performed.

In one embodiment, the analysis may include a correlation of lifestyle (or behavior) changing initiatives with lifestyle characteristics to determine the impact one or more lifestyle changing initiatives has on changing a lifestyle, as described above. For example, the lifestyle changing initiative may include sending intervention material (e.g., educational material etc.) to a smoker indicating the health risk of smoking, in an attempt to get the smoker to reduce or quit smoking (i.e., change the lifestyle characteristic). The correlation may also include a projected success characteristic of the lifestyle changing initiative. Some lifestyle changing initiatives may be targeted for the whole population as opposed to an identified portion of the population. For example, research may indicate where a cafeteria is operated on a companies premises, that offering at least one healthy meal, or portion thereof, helps improve the overall populations nutrition intake. In addition, the research may indicate that if the company subsidizes a designated healthy meal, that the overall nutrition of the population is improved even further. Lifestyle changing initiatives may include: providing (or making available) health related information to the members such as health books, including nutrition and cook books, health related audio or video recordings, providing recommended literature, providing telephone counseling, initiating a general health related questionnaire and a targeted health related questionnaire where appropriate, providing a newsletter including health related issues and/or program progress, identification and/or subsidizing of healthy (or healthier) foods in the cafeteria and vending machines, sponsoring walks, runs, health fairs, health screenings during, or after hours, including blood pressure screenings, mammography, sigmoidoscopy, subsidizing health club participation costs, providing cash incentives based upon program participation (such as reduced premiums), provide or subsidizing nicotine patches, establishing smoke awareness programs and smoke free policies, establishing wellness teams, providing lactating rooms for nursing mothers, establishing safety programs, fostering and/or demonstrating management program support, providing active wear with a health related logo, provide on site presentations, perform training meetings to human resource personnel (including communicating the initiatives and implementation techniques), communicating the business case to the facilitators of cultural change within the population, e.g., managers and line supervisors in a corporation, communicate to employees benefits of the health program and benefits of good health in general.

In one embodiment, health characteristics may be analyzed to analyze or track health care cost. For example medical and drug claims may be analyzed to determine general trends in the cost of these medical services, facilities, and associated treatments. In addition, the medical and drug claims, absenteeism, number of doctor visits, and number of days in a medical facility may be analyzed to determine the overall health care cost of the population, or the cost associated with a particular health risk, or a particular portion of the population.

In one embodiment, an action may be initiated in response to the analysis. For example, a behavioral change initiative may be performed in response to the analysis. In one embodiment, once a relationship between a lifestyle characteristic and a health risk has been established, an analysis of the population, or portion thereof, may be performed to determine which members of the population exhibit the lifestyle characteristic that may lead to the health risk. For example, an analysis may be performed to determine which members of the population smoke cigarettes. In addition, the health related information of the repository may be analyzed to establish which lifestyle changing initiatives impact cigarette smoking. In one embodiment, multiple initiatives may impact the health risk. Therefore, additional analysis may be performed to determine which initiative(s) to perform. The initiative selection analysis will be described in more detail below. Once a lifestyle changing initiative has been selected, the initiative may be performed. For example, nicotine patches may be distributed to cigarette smokers, presentations may be given, etc.

In one embodiment, the analysis may include determining the participation level of the population in the health program. For example, where the population, or a portion thereof, have been sent health-related questionnaires, or self-assessment questionnaires, the participation level may be established in response to the number of questionnaires returned from the population. If the level of participation is below a desired threshold, then participation increasing initiatives may be performed. For example, if the participation level is below 90%, then health care premiums may be reduced for the members of the population participating in the program. In one embodiment, the participation incentives may include an indication of management support for the health program. For example, a video (including digital disk etc.) having managers express their support for the program, how the program ties to corporate objectives, their desire to have the population participate in the program etc., may be made and shown to the population or a portion thereof. Other forms of participation incentives may include subsidizing identified healthy meals, performing health screenings during the day, and subsidizing health club participation costs.

In one embodiment, an action is performed which includes sending a health related self-assessment questionnaire to the population, or a portion thereof. In one embodiment, the questionnaire may be a general self-assessment questionnaire, or a targeted questionnaire. The self-assessment questionnaire may be distributed, returned, and used in the establishment of the repository of health related information. In addition, the self-assessment questionnaire may be distributed in response to an analysis of the health-related information. For example, if a member's family health characteristics indicate a history of elevated blood pressure in the family, a questionnaire may be sent to obtain further information regarding the member's health. In one embodiment, the results of the self-assessment data may be analyzed to determine the member's willingness to change a particular lifestyle characteristic, of a willingness to change identified characteristics in general. For example, in one embodiment, a level, or stage, of willingness to change may be identified. For example, the stages may include pre-contemplation, contemplation, preparation, action, and maintenance level. In one embodiment, an action may be initiated in response to the level of willingness to change. For example, with regard to a smoker, the actions corresponding to the levels of willingness to change may include: pre-contemplation, contemplation and preparation—sending educational information associated with the risk of smoking, e.g., lung cancer etc., action stage—sending nicotine patches to the member, maintenance—initiating participation in a program designed to help keep former smokers from reverting.

In one embodiment, the health related information within the repository may be analyzed to establish the incidence of a health risk within the population, or portion thereof. The established population incidence may be compared with a national measured level, e.g., a national incidence level. In one embodiment, if the population incidence is higher than a national incidence, then an investigation, or analysis, may be performed to determine why the population incidence is greater than the national incidence. For example, the repository may be further analyzed to determine if the incidence of health risk varies with employment type, age, gender, location etc. If it is determined that a particular employment type has a higher incidence of a particular health risk than others in the population, or at the national level, than additional actions may be taken to determine if or what the relationship may be between the health risk and the employment type. Then additional actions may be taken to reduce the health risk for that employment type based on the analysis.

In one embodiment, the health related information, or a portion thereof, in the repository may include cost characteristics associated with the health-related information, as described above. For example, health risk may include a health care cost associated with treating the health risk. In addition, lifestyle-changing initiatives may include the cost of implementing the lifestyle changing initiative. In one embodiment, the management of the health care program may include correlating lifestyle characteristics with health risk (and an associated cost characteristic of the health risk). In addition, the lifestyle changing initiatives (and an associated success factor and cost characteristic) may be correlated with the lifestyle characteristic. Therefore a correlation may be made between the health risk of a member, the lifestyle characteristics of the member, and lifestyle changing initiatives associated with the lifestyle characteristics. Then “what if” analysis may be performed to determine a cost-effective solution to reducing the health risk in the most effective manner.

Therefore, analysis may be performed to manage the health care program with one or more of the objectives. The objectives may include determining the most cost-effective approach to improving the health care of the population. For example, if limited funding is available, analysis may be performed to identify the most cost-effective manner to improve the health of the population. Establishing which health risks have the highest mortality rate, and/or which have the highest health care cost, what lifestyles contribute the most to these health risks, what lifestyle changing initiatives have the highest success factors in improving the lifestyle behaviors, and how much do these initiatives cost leads to managing the health care program based on the available resources. This analysis may be performed to identify what initiatives to undertake to achieve the desired objectives, e.g., reduce health care cost while improving the health of the population.

In addition, the repository may be analyzed to identify or revise the effect a lifestyle has on a particular health risk. This may be done by analyzing the health related information associated with the members having a particular health risk, and identifying common characteristics that the members exhibit. Further analysis (or research) may be performed to determine which of the common characteristics do impact the health risk, and by how much. In this manner the repository may be used to conduct/direct future medical research.

In one embodiment, once an initiative has been undertaken, the effected portion of the population may be monitored, e.g., through further self-assessment forms and/or analysis of medical and drug claims, absenteeism, doctor visits, the number of days in a medical facility, to determine the actual success of the initiatives. That is, impact of the initiative on the subject population may be measured or analyzed. In this manner new initiatives may be tested to determine the impact on reducing the health risk, and the results stored. In this manner the health related information in the repository may be updated to reflect new initiatives, and/or customizing the success factors of the known initiatives based on the successes of the initiative with the established population, e.g., as opposed to using default success factors established in other populations. In addition, analysis may be performed to determine the impact on the lifestyle changing initiatives on program participants versus non-participants.

In one embodiment, projections of health characteristics or associated initiatives may be compared with actual results from the initiatives to establish or further define the effectiveness of initiatives. In this manner, projection methods may also be improved to better forecast the health needs of the population and/or to forecast the impact or cost characteristics of lifestyle changing initiatives and/or health risks.

In one embodiment, additional actions may be taken in response to the measurements of a prior initiative. For example, if a new initiative shows promise for reducing health risks among the population, the new initiative may be combined with other initiatives to see if further improvements may be made.

The repository of health related information may be used by a medical group, e.g., corporate medical group, a medical provider, or a medical research group), to direct medical research. For example, the population may be analyzed with respect to the health related information to determine trends in medical cost, new or revised impact of lifestyles on health risks, and new or revised impact on lifestyle changing characteristics on health risks.

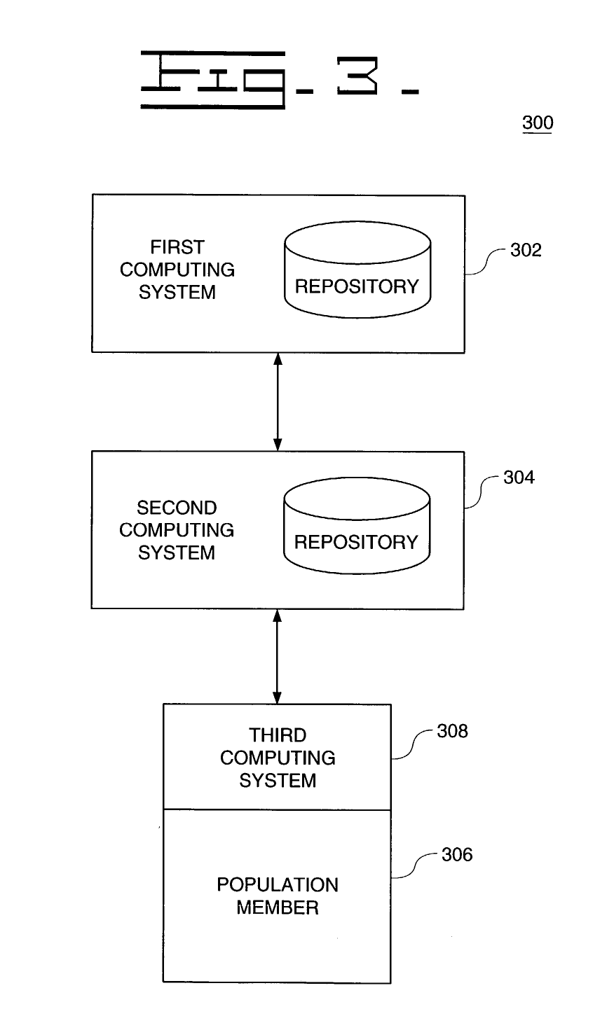

In one embodiment, a computing system may be configured to establish the repository of health related information described above. The computing system may be configured to establish a population having a plurality of members, and to receive health-related information associated with the members. The health related information includes a health characteristic, a family health characteristic, and a lifestyle characteristic associated with the member. The computing system would also include a repository configured to store said health related information. FIG. 3 illustrates one embodiment of such a system 300 configured to establish a repository of health related information. The system includes a first computing system 302 having a repository 312 of health related information associated with a portion of the population. As described below, the first computing system 302 may generate an electronic communication associated with the health related information associated with the first computing system 302, in response to either receiving an information request, the health related information associated with the first computing system being updated, or on a periodic basis. The system 300 also includes a second computing system 304 having a second repository 314 of health related information associated with the population. The second computing system 304 is configured to establish a population having a plurality of members. The health related information associated with the second computing system 304 includes at least one health characteristic, at least one family health characteristic, and at least one lifestyle characteristic associated with said member. The second computing system 304 is configured to receive the electronic communication from the first computing system and update the health related information stored in a repository 310 in response to the communication, analyze the health related information, and initiate an action in response to the analysis. In one embodiment, the second computing system 304 receives the electronic communication in response to the first computing system 302 updating the health-related information. That is, when the first computing system 302 updates the health related information associated with the first computing system 302 (e.g., one or more members records are updated), the system 302 automatically sends a communication signal to the second computing system 304 that is associated with the updated information. Alternatively, the second computing system 304 may periodically request an update to the health-related information that the first computing system 302 may have. The information request may be performed by sending an information request to the first computing system 302. In addition, the second computing system 304 may generate a request for health related information from the first computing system 302 in order to create the repository associated with the second computing system.

In one embodiment, the second computing system 304 is a web based system which enables a population member 306 to interact with the second computing system 304 via a third computing system 308. The interaction may include the population member 306 providing information associated with a health characteristic, family health characteristic, or lifestyle characteristic associated with them self. In one embodiment, the second computing system 304 is then able to analyze the repository in response to the health-related information and take an action in response to the analysis. The action may include automatically sending additional questionnaires to the third computing system 308, to obtain additional information. In addition, health related information associated with the population may be automatically delivered to the third computing system 308 based upon the health characteristic, family health characteristic, and lifestyle characteristics of the population member associated with the third computing system 308. For example, if the analysis of the repository indicates that the population member has a willingness to change their lifestyle, then one or more educational tools or intervention techniques may be electronically communicated to the population member. The intervention tools may include one or more videos or articles describing the correlation between a particular lifestyle of the individual and an associated health risk. The intervention tools may also identify some actions that may be taken by the population member, or by the health care program, that may help change the member's lifestyle. For example, if a member is over a desired weight, the program, at the member's request, may generate suggested meal menus for the member, and exercise routines to help reduce the weight, and improve overall health. The meal menus and exercise routines may be targeted to the particular member. In this manner, the system 300 is able to analyze the health-related information associated with the population, and manage the health care program in response to the analysis. For example, the second computer system 304 may perform an action in response to the analysis, as described above.

In one embodiment, the computer system 300 includes the second computing system 304 and associated repository. The first and third computing systems 302, 308, interface to the system 300, but are not considered part of the system 300 itself.

### INDUSTRIAL APPLICABILITY

The present invention includes a method and system configured to establish a repository of health related information. The health related information may be used to manage a health care program. The method includes the steps of establishing a population, the population having a plurality of members, and establishing said repository of health related information associated with at least one of said members, the health related information including a health characteristic, a family health characteristic, and a lifestyle characteristic associated with the member. The health care program may use the health related information to perform additional research into the cause and effect of health risks, and the effect of different lifestyle changing initiatives on changing the lifestyle characteristics that impact the health risk. The cause and effect of health risk may be impacted by lifestyle characteristics which may include location and employment related issues. The results of these analyses may be used to improve the work environment and/or location of employees if appropriate.

Therefore, analysis may be performed to manage the health care program with one or more of the objectives. This analysis may be performed to identify what initiatives to undertake to achieve the desired objectives, e.g., reduce health care cost while improving the health of the population.

Other aspects, objects, and advantages of the present invention can be obtained from a study of the drawings, the disclosure, and the claims.

What is claimed is:

1. A method of establishing a repository of health related information comprising the steps of:
establishing a population, said population having a plurality of members; and
establishing said repository of health related information associated with at least one of said members, said health related information including at least one health characteristic associated with said member, at least one family health characteristic associated with said member, and at least one lifestyle characteristic associated with said member, wherein at least one of said member health characteristic is obtained from an independent source.

2. A method, as set forth in claim 1, further comprising the steps of:
establishing a measurement of a health risk; and
storing said health risk measurement in said repository.

3. A method, as set forth in claim 2, wherein said health risk is a disease.

4. A method, as set forth in claim 2, wherein the step of establishing said health risk measurement further comprising the step of establishing at least one of a national incidence of said health risk and a population incidence of said health risk.

5. A method, as set forth in claim 2, wherein the step of said establishing said incidence further comprises the steps of:
establishing an age based measurement of said health risk; and
establishing a gender based measurement of said health risk.

6. A method, as set forth in claim 4, further comprising the steps of:
establishing a health care cost characteristic associated with said health risk; and
storing said health care cost characteristic in said repository.

7. A method, as set forth in claim 6, further comprising the steps of:
establishing an intervention method associated with changing said lifestyle characteristic;
establishing a success characteristic associated with said intervention method; and
storing said intervention method and said intervention success characteristic in said repository.

8. A method, as set forth in claim 7, further comprising the steps of:
correlating an impact said lifestyle characteristic has on causing said health risk; and
storing said health risk impact correlation in said repository.

9. A method, as set forth in claim 8, wherein said member health characteristic further includes at least one of a medical claim characteristic, a drug claim characteristic, a self assessment characteristic, a death characteristic, an absenteeism characteristic, a number of days spent in a medical facility, and a number of visits to a doctor.

10. A method, as set forth in claim 9, where said self assessment characteristic includes at least one of a self-reported health characteristic, and a willingness to change characteristic indicative of said members willingness to change said lifestyle characteristic.

11. A method, as set forth in claim 10, wherein said willingness to change characteristic is associated with a willingness to change stage.

12. A method, as set forth in claim 1, wherein said willingness to change stage includes one of a pre-contemplation stage, a contemplation stage, a preparation stage, an action stage, and a maintenance stage.

13. A method, as set forth in claim 9, wherein said member family health characteristic further includes a historical family health characteristic.

14. A method, as set forth in claim 13, wherein said member lifestyle characteristic further includes a modifiable lifestyle characteristic.

15. A method, as set forth in claim 14, wherein said modifiable lifestyle characteristic includes at least one of an exercise characteristic, a nutrition characteristic, a smoking characteristic, a stress characteristic, a safety characteristic, a drug intake characteristic, a hypertension characteristic, a self care characteristic, a self efficacy characteristic, a weight characteristic, and a prophylactic aspirin therapy characteristic.

16. A method, as set forth in claim 14, wherein said health-related information further includes at least one of a geography, an age, a gender, an employment type, and an employment status of said at least one of said members.

17. A method, as set forth in claim 1, further comprising the step of analyzing said health related information.

18. A method, as set forth in claim 17, further comprising the step of initiating an action in response to said analysis.

19. A method, as set forth in claim 18, further comprising the step of measuring at least one of a change in health cost and a change in health characteristic in response to said action.

20. A method, as set forth in claim 17, wherein the step of said analysis further includes the step of correlating at least one of said member lifestyle characteristics with a health risk.

21. A method, as set forth in claim 20, wherein the step of initiating an action further includes the step of performing a lifestyle change initiative in response to said correlation.

22. A method, as set forth in claim 21, wherein the step of performing said lifestyle change initiative further comprises the step of providing at least one of a telephone counseling to said member, a targeted information associated with said correlation to said member, and a targeted questionnaire to said member.

23. A method, as set forth in claim 22, wherein said targeted information further includes at least one of an health related audio recording, a recommended health book, a recommended literature, a health related video recording.

24. A method, as set forth in claim 17, wherein the step of performing said analysis further includes the steps of:
managing a health care program in response to said analysis
determining a participation level of said population in said health care program; and
providing a participation incentive to at least a portion of said population in response to said participation level being below a desired threshold.

25. A method, as set forth in claim 24, wherein said participation incentive includes providing a premium reduction in response to a completion of a self-assessment questionnaire.

26. A method, as set forth in claim 25, wherein said participation incentive includes an indication of management support.

27. A method, as set forth in claim 26, wherein said indication of management support includes at least one of a video including said management, and a management endorsed corporate health statement.

28. A method, as set forth in claim 24, further comprising the steps of:
communicating said health initiative to a human resource manager;
communicating a business case associated with said health initiative to a manager; and
communicating at least one benefit of said health initiative to at least a portion of said population.

29. A method, as set forth in claim 24, wherein the step of providing said participation incentive further comprises the step of subsidizing a designated health food.

30. A method, as set forth in claim 29, wherein the step of providing said participation incentive further comprises the step of providing health screenings.

31. A method, as set forth in claim 30, wherein the step of providing said participation incentive further comprises the step of subsidizing a health club membership.

32. A method, as set forth in claim 17, wherein the step of said analysis further comprises the step of determining a willingness to change a lifestyle behavior.

33. A method, as set forth in claim 32, wherein the step of determining a willingness to change further comprises the step of determining said willingness to change said lifestyle characteristic in response to a self assessment questionnaire.

34. A method, as set forth in claim 33, wherein the step of determining a willingness to change further comprises the step of identifying a level of said willingness to change.

35. A method, as set forth in claim 34, wherein said level includes one of a pre-contemplation level, a contemplation level, a preparation level, an action, and a maintenance level.

36. A method, as set forth in claim 34, wherein the step of initiating said action includes the step of initiating an action in response to said identified level of said willingness to change.

37. A method, as set forth in claim 17, wherein the step of performing said analysis further comprises the steps of:
identifying a population incidence of a disease in response to said member health characteristic; and
comparing said population incidence of said disease to said national incidence of disease.

38. A method, as set forth in claim 37, further comprising the steps of:
determining said population incidence of said disease is greater than said national incidence of said disease; and
identifying a cause of said greater population incidence of said disease in response to said health related information.

39. A method of managing a health care program comprising the steps of:
establishing a population to be managed, said population having a plurality of members;
developing a repository of health related information associated with at least one of said members, said health related information including at least one health characteristic associated with said member, at least one family health characteristic associated with said member, and at least one lifestyle characteristic associated with said member, wherein at least one of said one health characteristic is obtained from an independent source;
analyzing said health related information; and
managing said program in response to said analysis.

40. A method, as set forth in claim 39, wherein the step of managing said program further comprises the step of performing an action based on said analysis.

41. A method, as set forth in claim 40, wherein the step of managing said program further comprises the steps of:
recording a result of said action;
analyzing said result; and
performing a second action in response to said result analysis.

42. A method, as set forth in claim 39, wherein the step of analyzing said program further comprises the steps of:
establishing at least one health risk associated with said population; and
establishing at least one relationship between at least one of said lifestyle characteristics and said health risk.

43. A method, as set forth in claim 42, further comprising the steps of:
establishing at least one lifestyle changing initiatives;
correlating said lifestyle-changing initiatives with at least one of said health risk.

44. A method, as set forth in claim 43, further comprising the steps of:
establishing at least one member having said correlated health risk and said lifestyle characteristic.

45. A method, as set forth in claim 44, wherein the step of performing said action further comprises the step of initiating said lifestyle changing initiative for said health member having said correlated health risk.

46. A method, as set forth in claim 39, wherein the step of analyzing said program further comprises the steps of:
recording a result associated with said action;
analyzing said results; and
modifying said relationship between said lifestyle characteristic and said health risk.

47. A method, as set forth in claim 39, wherein the step of analyzing said program further comprises the steps of:
recording a result associated with said action;
analyzing said results; and
modifying said lifestyle behavior initiative success characteristic in response to said analysis.

48. A method, as set forth in claim 45, further comprising the steps selecting said action in response to a success characteristic of said initiative.

49. A method, as set forth in claim 45, further comprising the steps of:
establishing a cost of said lifestyle changing initiative; and
selecting said action in response to a success characteristic of said initiative and said initiative cost.

50. A method, as set forth in claim 45, further comprising the steps of:
establishing a budget associated with said program;
establishing a cost of said lifestyle changing initiative; and
selecting said action in response to a success characteristic of said initiative, said initiative cost, and said program budget.

51. A method, as set forth in claim 45, further comprising the steps of:
establishing a willingness of change characteristic associated with said correlated health risk; and
selecting said initiative in response to said willingness to change characteristic.

52. A method, as set forth in claim 40, where the step of analyzing said repository further comprises the step of establishing a participation level in said program.

53. A method, as set forth in claim 41, wherein the step of establishing said repository includes establishing at least one of said health characteristic, said family characteristic, and said lifestyle characteristic, by at least one of conducting a phone interview, conducting a personal interview, providing a web based questionnaire, and delivering a plurality of questionnaires to said members.

54. A method, as set forth in claim 39, wherein the step of performing an action further comprises the step of providing an incentive to said members to increase said participation.

55. A method, as set forth in claim 39, wherein the step of establishing said repository further comprises the step of sending a plurality of questionnaires to at least one of said members.

56. A method, as set forth in claim 39, wherein the step of managing said program further comprises the step of sending a targeted questionnaire to at least one member in response to said analysis.

57. A system configured to establish a repository of health related information including, comprising:
a computing system configured to establish a population having a plurality of members, and further configured to receive health related information associated with said members, said health related information include a health characteristic, a family health characteristic, and a lifestyle characteristic associated with said member, wherein at least one of said member health characteristic is obtained from an independent source; and
a repository associated with said computing system, said repository being configured to store said health-related information.

58. A system, as set forth in claim 57, wherein said computing system is further configured to receive a portion of said health related information from an electronic communication sent from a second computing system.

59. A system configured to establish a repository of health related information including, comprising:
a first computing system having a repository of health related information, said first computing system generating an electronic communication associated with said health related information, in response to one of an information request signal and said health related information being updated; and
a second computing system having a repository of health related information, said second computing system being configured to establish a population having a plurality of members, said health related information including at least one health characteristic, at least one family health characteristic, and at least one lifestyle characteristic associated with said member; said second computing system being further configured to receive said electronic communication and update said health related information in response to said signal, analyze said health related information, and initiate an action in response to said analysis.

60. A method of establishing a repository of health related information comprising the steps of:
establishing a population, said population having a plurality of members, wherein at least a portion of said members are employed by an organization;
establishing said repository of health related information associated with at least one of said members, said health related information including at least one health characteristic associated with said member, at least one family health characteristic associated with said member, and at least one lifestyle characteristic associated with said member; and
maintaining said employee members health related information during employment by said organization.

61. A method of managing a health care program comprising the steps of:
establishing a population to be managed, said population having a plurality of members, wherein at least a portion of said members are employed by an organization;
developing a repository of health related information associated with at least one of said members, said health related information including at least one health characteristic associated with said member, at least one family health characteristic associated with said member, and at least one lifestyle characteristic associated with said member;
maintaining said employee members health related information during employment by said organization;
analyzing said health related information; and
managing said program in response to said analysis.
